(19) United States
(12) Patent Application Publication
(10) Pub. No.: US 2007/0028574 A1
(43) Pub. Date: Feb. 8, 2007

(54) DUST COLLECTOR FOR AUTONOMOUS FLOOR-CLEANING DEVICE

(76) Inventor: Jason Yan, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/161,394

(22) Filed: Aug. 2, 2005

(51) Int. Cl. B01D 46/00

(52) U.S. Cl. 55/503

(57) ABSTRACT

A dust collector for use in an autonomous floor-cleaning device is disclosed to include a container, which is formed of a container body and a top cover shell and has two bottom suction holes and a top air outlet, a box-like partition member, which divides the inside space of the container into a bottom storage chamber and an upper storage chamber and has a through hole in communication between one bottom suction hole and the air outlet, and a filter member set between the through hole of the partition member and the air outlet of the container for removing dust from air passing through the upper storage chamber.

### BACKGROUND OF THE INVENTION

1. Field of the Invention

The present invention relates to dust collecting apparatus and more particularly to a dust collector for use in an autonomous floor-cleaning device.

2. Description of the Related Art

It is a hard labor to a housekeeper to clean the floor with a hand-operated vacuum cleaner. In recent years, many autonomous floor-cleaning devices have been disclosed and have appeared on the market. U.S. Pat. No. 6,883,201 discloses an autonomous floor-cleaning robot that is operable without human intervention to clean designated areas. As shown in FIG. 5A of the specification of said patent, the autonomous floor-cleaning robot has a top cover shell and a bottom cover shell fastened together with screws, and a backwall member 86BW that divides the inside space into a first storage chamber 86SC1 and a second storage chamber 86SC2. The first storage chamber 86SC1 is for the macroscopic and microscopic particulates swept up by the dual-stage brush assembly of the autonomous floor-cleaning robot. The second storage chamber 86SC2 is for microscopic particulates drawn in by the vacuum assembly of the autonomous floor-cleaning robot. However, this design of autonomous floor-cleaning robot is still not satisfactory in function. Because the cover shells are fastened together with screws, it is complicated to detach the cover shells for cleaning the inside parts of the autonomous floor-cleaning robot. Further, the design of the grooves at the cover shells and the use of the packing rubber at the grooves to maintain an airtight status greatly increase the manufacturing cost of the robot.

### SUMMARY OF THE INVENTION

The present invention has been accomplished under the circumstances in view. It is the main object of the present invention to provide a dust collector for autonomous floor-cleaning device, which is easy to clean and inexpensive to manufacture. To achieve this and other objects of the present invention, the dust collector is mounted in the air flowing path inside an autonomous floor-cleaning device, comprising a container, a partition member, and a filter member. The container comprises a container body, and a top cover shell attached to the container body and defining with the container body an inside space. The container body has a first suction hole and a second suction hole for guiding air into the inside space. The top cover shell has an air outlet for guiding air out of the inside space. The partition member is horizontally positioned in the container body, dividing the inside space of the container into an upper storage chamber and a bottom storage chamber. The partition member has a through hole in air communication between the first suction hole and the air outlet. The filter member is set between the through hole of the partition member and the air outlet of the top cover shell and adapted to remove dust from air passing through the upper storage chamber.

### BRIEF DESCRIPTION OF THE DRAWINGS

FIG. 1 is an exploded view of a dust collector for autonomous floor-cleaning device according to the present invention.

FIG. 2 is a sectional elevation of the container body of the container of the dust collector according to the present invention.

FIG. 3 is a sectional assembly view of the dust collector according to the present invention.

### DETAILED DESCRIPTION OF THE PREFERRED EMBODIMENT

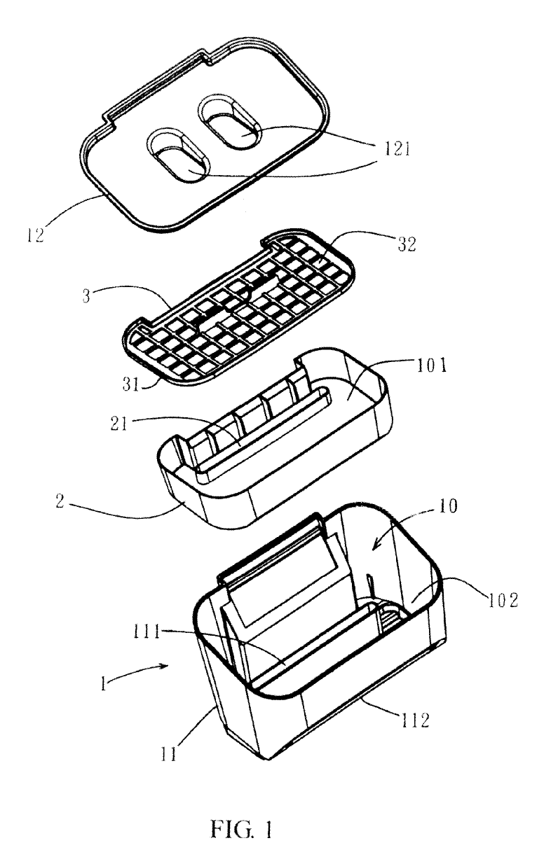

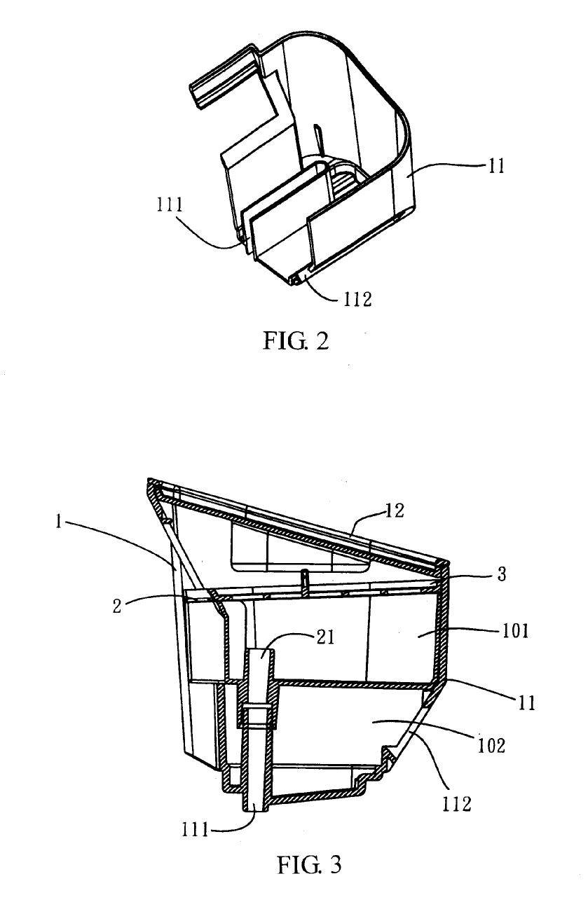

Referring to FIGS. 1˜3, a dust collector in accordance with the present invention is shown comprised of a container 1, a partition member 2, and a filter member 3.

The container 1 comprises a container body 11 and a top cover shell 12 detachably fastened to the container body 11 to close the top open side of the container body 11 by means of friction resistance. The container 1 defines therein an inside space 10. The container body 11 has a first suction hole 111 and a second suction hole 112. The top cover shell 12 has an air outlet 121. During operation of the autonomous floor-cleaning device (not shown) in which the dust collector is installed, air flows into the inside space 10 through the first suction hole 111 and the second suction hole 112 and then flows out of the inside space 10 through the air outlet 121.

The partition member 2 is shaped like a flat box fitting the container body 11. The partition member 2 is horizontally positioned in the container body 11, dividing the inside space 10 into an upper storage chamber 101 and a bottom storage chamber 102. The partition member 2 has a through hole 21 in air communication with the first suction hole 111.

The filter member 3 comprises a rack 31 and a paper filter 32 fastened to the rack 31. The filter member 3 is covered on the partition member 2 and set between the through hole 21 of the partition member 2 and the air outlet 121 of the top cover shell 12 to remove dust from air passing through the upper storage chamber 101.

As indicated above, the partition member 2 divides the inside space 10 of the container 1 into the aforesaid upper storage chamber 101 and bottom storage chamber 102. During cleaning operation of the autonomous floor-cleaning device, microscopic particulates drawn in by the vacuum assembly (not shown) of the autonomous floor-cleaning device pass through the first suction hole 111 into the upper storage chamber 101 and then stopped in the upper storage chamber 101 by the paper filter 32. Macroscopic and microscopic particulates swept up by the brush assembly (not shown) of the autonomous floor-cleaning device are sucked into the bottom storage chamber 102 through the second suction hole 112. After each use of the autonomous floor-cleaning device, the component parts of the dust collector can conveniently be detached from one another for cleaning.

Further, the paper filter 32 of the filter member 3 has a wide working area, preventing quick blocking of the open spaces in the paper filter 32 by microscopic particulates. Further, the border area of the paper filter 32 extends over the periphery of the rack 31 for use as packing means that is set in between the outside wall of the partition member 2 and the inside wall of the container body 11 to seal the gap. Therefore, no additional packing rubber is needed to seal the gap in between the outside wall of the partition member 2 and the inside wall of the container body 11.

Although a particular embodiment of the invention has been described in detail for purposes of illustration, various modifications and enhancements may be made without departing from the spirit and scope of the invention.

What is claimed is:

1. A dust collector mounted in an autonomous floor-cleaning device in the air flowing path, comprising
a container, said container comprising a container body, and a top cover shell attached to said container body and defining with said container body an inside space, said container body having a first suction hole and a second suction hole for guiding air into said inside space, said top cover shell having an air outlet for guiding air out of said inside space;
a partition member horizontally positioned in said container body, said partition member dividing said inside space into an upper storage chamber and a bottom storage chamber, said partition member having a through hole in air communication between said first suction hole and said air outlet; and
a filter member set between the through hole of said partition member and the air outlet of said top cover shell and adapted to remove dust from air passing through said upper storage chamber.

2. The dust collector as claimed in claim 1, wherein said partition member is shaped like a flat box.

3. The dust collector as claimed in claim 2, wherein said filter member comprises a rack covered on said partition member, and a paper filter fastened to said rack.

4. The dust collector as claimed in claim 3, wherein said paper filter has a border area extended over the periphery of said rack and sandwiched in between an outside wall of said partition member and an inside wall of said container body to seal the gap between said partition member and said container body.
